(19) United States
(12) Patent Application Publication
(10) Pub. No.: US 2009/0040746 A1
(43) Pub. Date: Feb. 12, 2009

(54) NOVELTY STICK HOLDERS FOR FOOD ON STICKS

(75) Inventors: Sarid M. Shefet, Cary, NC (US); Steven C. Klawiter, Garner, NC (US); Richard Rodeheaver Hawkins, Raleigh, NC (US); Lawrence Alan Chandler, Raleigh, NC (US)

Correspondence Address: MYERS BIGEL SIBLEY & SAJOVEC, PO BOX 37428, RALEIGH, NC, 27627, US

(73) Assignee: RDI Foods, L.L.C., Raleigh, NC (US)

(21) Appl. No.: 12/186,322

(22) Filed: Aug. 5, 2008

Related U.S. Application Data
(60) Provisional application No. 60/955,102, filed on Aug. 10, 2007.

(51) Int. Cl. F21V 9/16; F21V 33/00; A47J 37/04; A63H 5/00

(52) U.S. Cl. 362/84; 362/109; 362/253; 294/5.5; 294/61; 446/81

(57) ABSTRACT

Novelty themed stick holders for food items include an elongate holder having an external surface and opposing top and bottom portions defining an elongate receiving cavity therebetween. The cavity is configured and sized to receive a stick therein. In some embodiments, the holder tapers inwardly from a top portion to a bottom portion and defines a handle portion of a miniature baseball bat. Other themes and shapes are also described.

### RELATED APPLICATION

This application claims the benefit of priority to U.S. Provisional Application Ser. No. 60/955,102, filed Aug. 10, 2007, the content of which is hereby incorporated by reference as if recited in full herein.

### BACKGROUND

The invention relates to holders for edible food held on sticks.

### SUMMARY OF EMBODIMENTS OF THE INVENTION

Embodiments of the invention are directed to novelty-themed stick holders for edible food items.

Some embodiments are directed to novelty themed stick holders for a food item held on a stick that includes an elongate holder with an external surface and opposing top and bottom portions defining an elongate receiving cavity therebetween. The cavity is configured and sized to receive a stick therein.

In some embodiments, the external surface of the holder can taper inwardly from a top portion to a bottom portion and defines a handle portion of a miniature baseball bat. In other embodiments, an outer surface of the holder can taper inwardly from a bottom portion to a top portion or not taper at all. The holder cavity can be sized and configured to snugly receive the stick.

The stick holder can be used in combination with a corn dog or hot dog. The corn dog or hot dog extends above the holder and defines a continuous perimeter line extending from the top portion of the holder to define the medial and top portion of the miniature baseball bat.

Other embodiments are directed to novelty stick holders for food items held by a stick that include a themed stick holder for a food item held on a stick. The stick holders have an elongate themed stick holder body with an external surface and a novelty themed appearance and shape. The holder body has opposing top and bottom portions defining an elongate receiving cavity therebetween. The cavity is configured and sized to receive and hold a second end portion of a stick with a food item held on an opposing first end portion. Some embodiments are directed to novelty stick holders for food items held by a stick that include an edible elongate themed stick holder body with an external surface and a novelty themed appearance and/or shape. The holder body has opposing top and bottom portions defining an elongate receiving cavity therebetween. The cavity is configured and sized to receive and hold a first end portion of a stick with a first food item held on an opposing second end portion in the cavity.

Yet other embodiments are directed to kits of novelty themed stick holders that include a container holding a plurality of novelty themed stick holders. Each novelty themed stick holder is adapted to receive a food item held on a stick. The novelty themed stick holders have an elongate themed stick holder body with an external surface and a novelty themed appearance and shape, the holder body having opposing top and bottom portions defining an elongate receiving cavity therebetween with the cavity configured and sized to snugly receive and hold a stick with a food item thereon in the cavity.

The themed stick holders may be held in a bulk package and/or individually wrapped for attachment at food dispensing and/or preparation location. In other embodiments, the stick holders can be applied at a manufacturing site and packaged pre-assembled, particularly where no or minimal cooking may be required. In yet other embodiments, the stick holders can be included in a package with a food item for assembly by a consumer. The themed stick holders can be packaged and held in a bag meeting USFDA (the United States Food and Drug Administration) cleanliness guidelines. The novelty themed stick holders may be reusable and/or dishwasher safe.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1A is an end perspective view of a corndog or hot dog on a stick.

FIG. 1B is an end perspective view of the corndog or hot dog on the stick with the stick held in a novelty-themed stick holder according to embodiments of the present invention.

FIG. 2 is a schematic perspective view of the holder shown in FIG. 1B but modified to have a pocket or clip to retain a wipe, napkin or condiment according to embodiments of the invention.

FIG. 3 is a schematic perspective view of the holder shown in FIG. 1B that also includes a whistle and/or that is configured to emit light according to embodiments of the present invention.

FIG. 4 is a front view of a holder shaped as a school mascot according to embodiments of the present invention.

FIG. 5 is a front view of two different animal shaped holders according to other exemplary embodiments of the present invention.

FIG. 6 is a front view of six different “chess” piece holders according to other exemplary embodiments of the present invention.

FIG. 7 are front views of additional exemplary novelty themed holders according to embodiments of the present invention.

FIG. 8A is a schematic illustration of an elongate cavity configured to slidably snugly receive a stick according to embodiments of the present invention.

FIGS. 8B-8D illustrate alternate configurations of internal fin or rib members according to embodiments of the present invention.

FIG. 8E is an end view of the configuration shown in FIG. 8A.

FIGS. 8F-8I are end views of illustrate configurations of internal fin or rib members according to embodiments of the present invention.

FIGS. 9A and 9B are schematic illustrations of a holder with a deformable cavity shape according to embodiments of the present invention.

FIGS. 10A and 10B are schematic illustrations of a holder cavity with a curved interior wall according to embodiments of the present invention.

FIG. 10C is a schematic illustration of a holder that deforms in response to insertion of the stick (or stick insert) according to embodiments of the present invention.

FIG. 11A-11B are schematic illustrations of a holder cavity with dimples or ribs according to embodiments of the present invention.

FIGS. 12A and 12B are schematic sectional views of an insert according to embodiments of the present invention.

FIGS. 13A-13D are schematic sectional views of the insert shown in FIG. 12B illustrating alternate holding configurations with respect to a holder and the stick with food according to embodiments of the present invention.

FIG. 14 is a sectional view of a threaded holder cavity according to other embodiments of the present invention.

FIGS. 15A-15G are front views of additional exemplary holders according to embodiments of the present invention.

FIGS. 16A-16D are front views of yet other exemplary holders according to embodiments of the present invention.

FIG. 17 is a schematic illustration of a stick holder configured to accept discrete accessory or decorative components according to embodiments of the present invention.

FIG. 18 is a side perspective view of a multi-component stick holder according to embodiments of the present invention.

FIGS. 19A-19C are schematic illustrations of internal cavity configurations according to embodiments of the present invention.

FIGS. 20A and 20B are schematic illustrations of internal cavity configurations comprising an adhesive layer or strip(s) according to some embodiments of the present invention.

FIGS. 21A-21C are schematic illustrations of cavity size relative to stick size according to embodiments of the present invention.

FIGS. 22A-22C are schematic illustrations of different stick holder end configurations according to embodiments of the present invention.

FIG. 23 is a schematic illustration of a kit of holders packaged for use/sale according to embodiments of the present invention.

FIG. 24 is a schematic illustration of a package comprising a food item on a stick and a stick holder according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise. A feature shown with respect to one embodiment can be implemented in other embodiments although not specifically shown or discussed with respect to that other embodiment.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

The term “novelty themed” refers to an item that has a shape and/or appearance that represents or brings to mind an event, occasion, organization, company, school, movie, licensed character, mascot or symbol and is typically suitable for retention as a souvenir of attendance or as an advertising item. The holders may be particularly suitable as a holder for food items sold at sporting events or state fairs. The novelty themed holder can be customized to a particular use or occasion, or be produced under license with a licensed trademark or copyright shape or appearance.

The holders can be configured to hold any suitable food item held on a stick. The stick can be a planar stick such as a popsicle-like stick or a round (cylindrical) stick. The term “popsicle-like” stick refers to a stick that is elongate and substantially planar, similar to a conventional popsicle stick, but may be more narrow or wider, longer and/or shorter. The stick cross-sectional shape may also be other geometric or free shape, such as, for example, triangular, square, diamond shaped, and the like. The stick may also vary its cross-sectional shape along a length thereof. For increased cost efficiency, the holder can be configured to use a stick “as-is” without requiring any modification to its current commercial configuration. In other configurations, the lower portion of the stick may be modified, such as threaded or provided with an anchoring portion for insertion and retention into a (threaded) cavity of the holder.

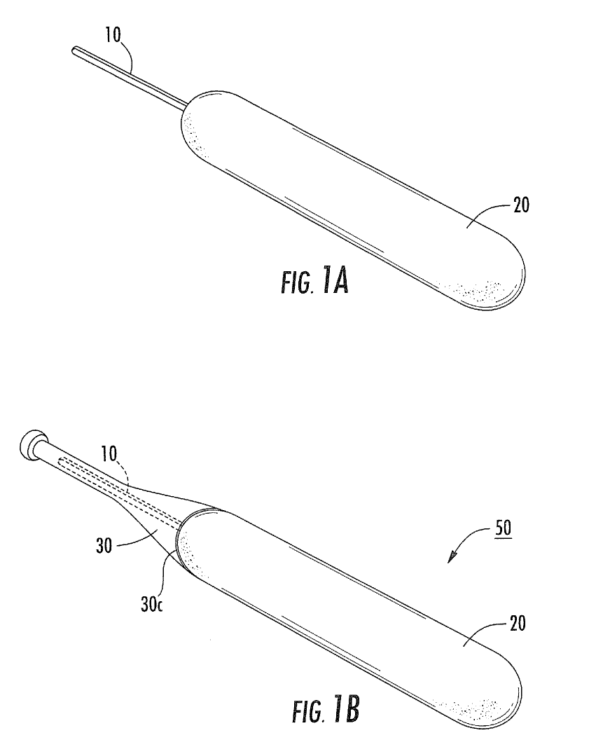

As shown in FIGS. 1A and 1B, the food item 20 may be a hot dog or corn dog held on a stick 10. The stick 10 is held in the holder 30. The holder 30 has an elongate cavity 32 (FIGS. 3, 8A, 9A, 10A, 11A-11C).

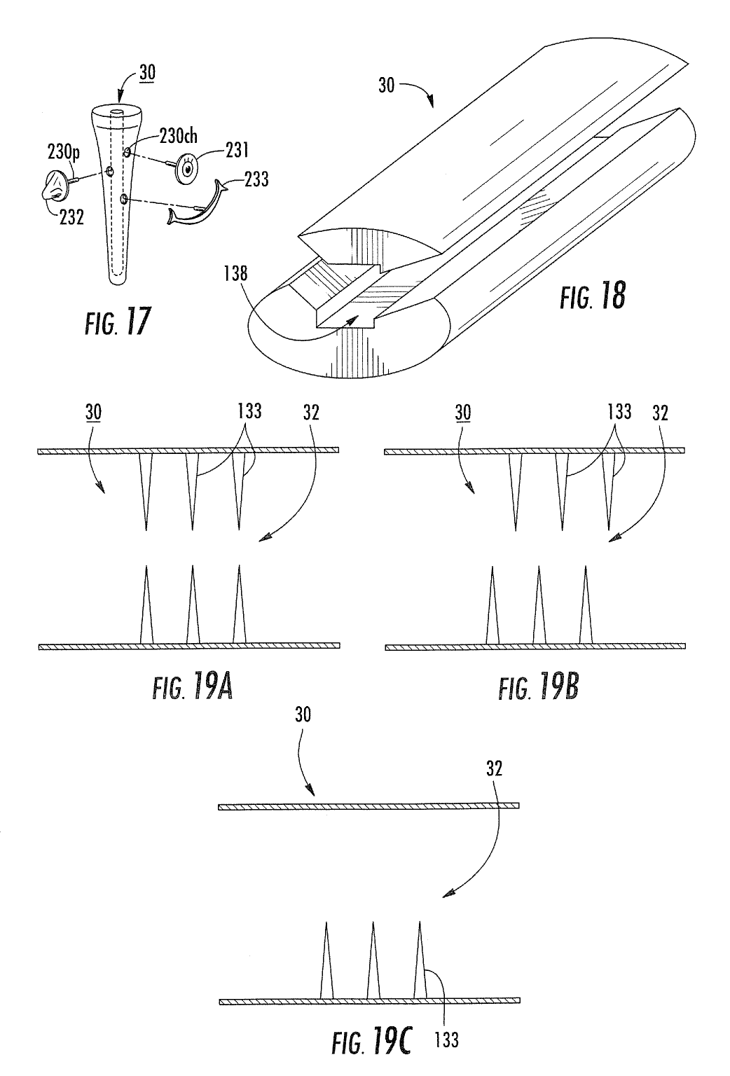

The novelty themed holder 30 can be molded as a single piece body or may be a multiple piece configuration (e.g., FIG. 18) as will be discussed below. The holders 30 can be sized and configured to meet choke resistant standards for young children (e.g., be age appropriate for children, such as at least those above 3 years old) so that the insert does not include unduly small or loose parts. The holders 30 can be single-use disposable, but are typically event or party “favors” that can be retained after the food item is consumed (and the stick disposed of) allowing a consumer the choice of taking the holder 30 home as a souvenir. The holders 30 may be dishwasher safe, with the body able to withstand a predetermined number of wash cycles, as defined by (U.S. Federal) and/or other applicable regulatory standards. The holder 30 can comprise an elastomeric material, plastic, wood, cardboard, stiff paper, metal, ceramic and the like. The holders 30 may also comprise edible material (wholly or in-part), such as hard sugar candy, low melt chocolate, baked goods, icing, and the like.

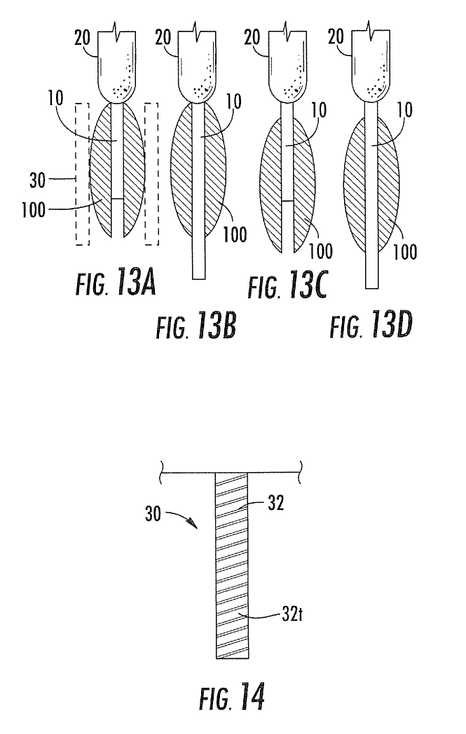

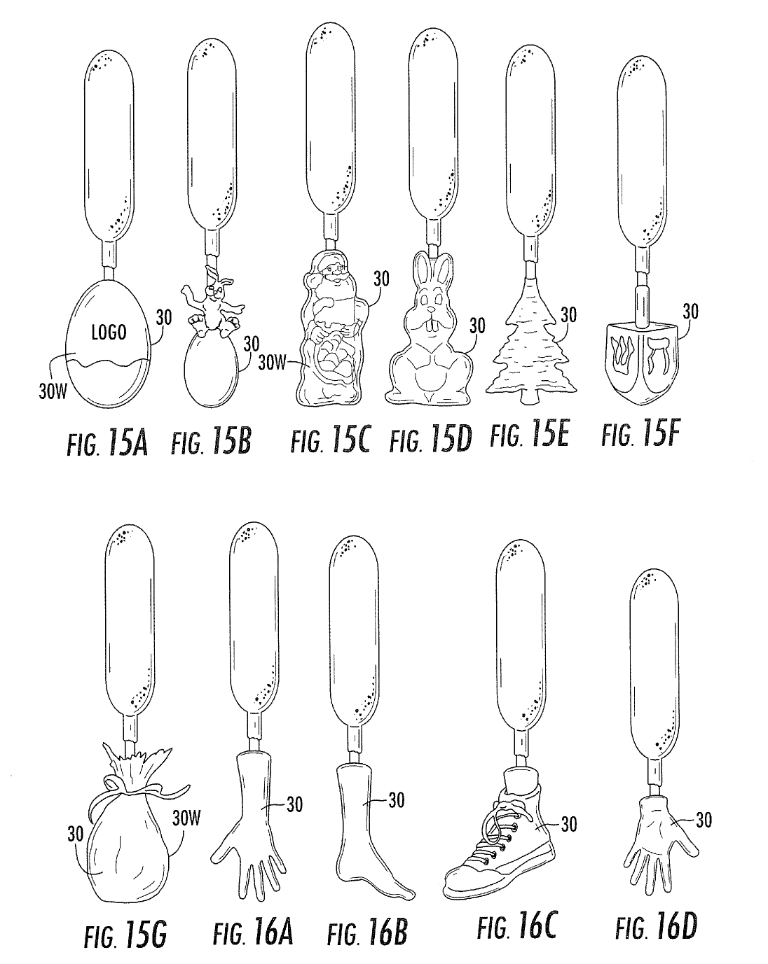

As shown in FIGS. 15A-15G, the holder 30w can comprise a sweet, desert and/or confectionary item that can be eaten after the food item on the top portion of the stick is eaten (or before or concurrently as desired). In some embodiments, the combination of a protein item on one end of the stick and a dessert on the other provides a meal-on-a-stick configuration. As shown in FIGS. 15A, 15C and 15G, the holder 30 can include an overwrap 30w, such as foil or an elastomeric film, or combinations thereof which can hold the underlying food until ready for consumption by a consumer. The wrap 30w may include a thermal insulating layer to inhibit early melting by heat from a user's hand or the upper food item. FIGS. 15A-15G also illustrate that the holder 30 can be configured in a holiday, religious or other desirable theme (edible or not).

As shown in FIG. 1B, the holder 30 is particularly suitable for a corn dog or hot dog on a stick. However, the food item may be any food item held on a stick, whether meat, vegetable or desert and whether heated, cold or in a frozen state. Examples of food items on a stick include, popsicles and ice cream products, corn dogs, hot dogs, corn on the cob, cotton candy, fried candy bars (such as those offered at carnivals and state fairs), other confectionary items, such as individual sized cakes, candy apple, kabob, and the like.

The holder 30 and/or food item may also include printed visual indicia such as a sports or team motif on an outer surface thereof. If on the food item, an edible dye or coloring can be used.

Again referring to FIG. 1B, the holder 30 can be configured to be an extension of the hot dog or corn dog so as to together define a miniature replica of a baseball bat. The top of the holder 30 can be substantially concave 30c (with the concavity facing upward) corresponding to the curvature of the lower end of the food item to receive a lower end of the hot dog/corn dog and define a continuous perimeter line with the holder 30. The holder 30 can taper inwardly along its length to the bottom end to define the handle portion of the miniature baseball bat while the food item defines the medial and upper portion. The holder 30 can have any suitable length and width, the length typically being less than the corresponding product with a sufficient mass to be able to support the food item 20.

As shown in FIG. 2, the holder 30 with food 20 can be an assembly 50 that can also hold a condiment package, wipe and/or napkin 45. The holder can include a band, pocket, pouch and/or clip 40 that holds the item(s). Alternatively, adhesive can be used to hold the item.

As shown in FIG. 3, the holder 30 can be configured to house a power source, such as a pancake-style or other small battery 60. The body of the holder 30 can be configured to emit light 61 (continuous and/or blinking), which may be emitted via light channels 62 or in other ways upon activation of the battery 60. The holder 30 can be configured to emit a light not emitted by the channels, and/or fluoresce or glow. The holder 30 can optionally include an integrated LCD screen 66 in communication with the battery 60. The holder 30 can be configured to generate an auditory output from an integrated sound source 64 in communication with the battery 60 or a mechanical sound maker such as a buzzer, clicker or whistle. The holder 30 can be configured with to output a single one of audio or visual output, e.g., light or auditory/sound output, or combinations of sound and light output. The holder 30 can include the LCD 66 alone or, as shown, the holder 30 can include the LCD 66, a light emitter 61 and a sound generator 64. The holder 30 can include a circuit and user input that allows a user to adjust a light cycle (not shown). As also shown in FIG. 3, alternatively or additionally, the holder 30 sound source 64 can be a whistle 65 that is useable with and/or after the food item has been consumed. Other sound sources 64, electronic and/or mechanical, may also be provided (e.g., a clicker or an audio DSP signal that can say or sing “Happy Birthday” or other messages, cheers, songs, and the like). In addition, the holder body and/or holder cavity 32 can also house dry or wet supplemental edible material, including one or more of condiments such as, for example, salt, pepper, sugar, spices, dry creamer and/or ketchup, mustard, wet creamer and the like.

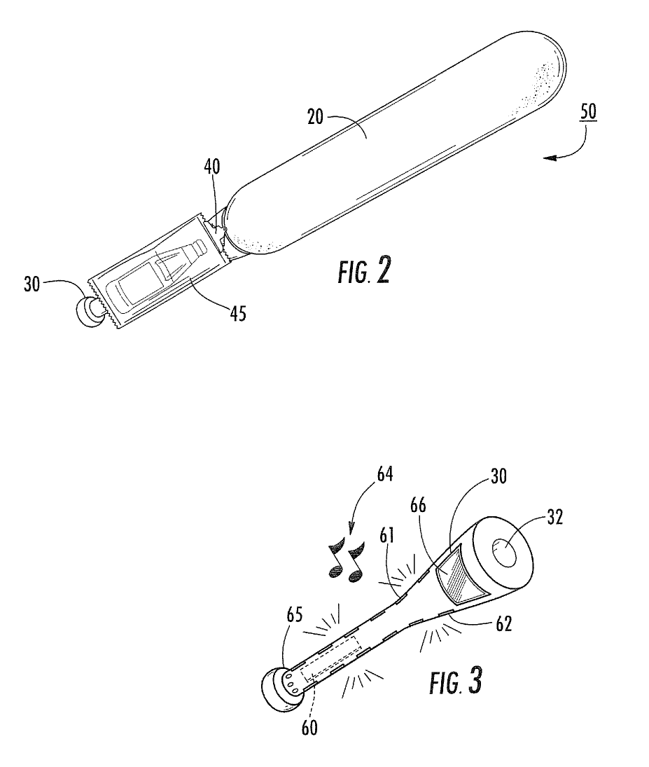

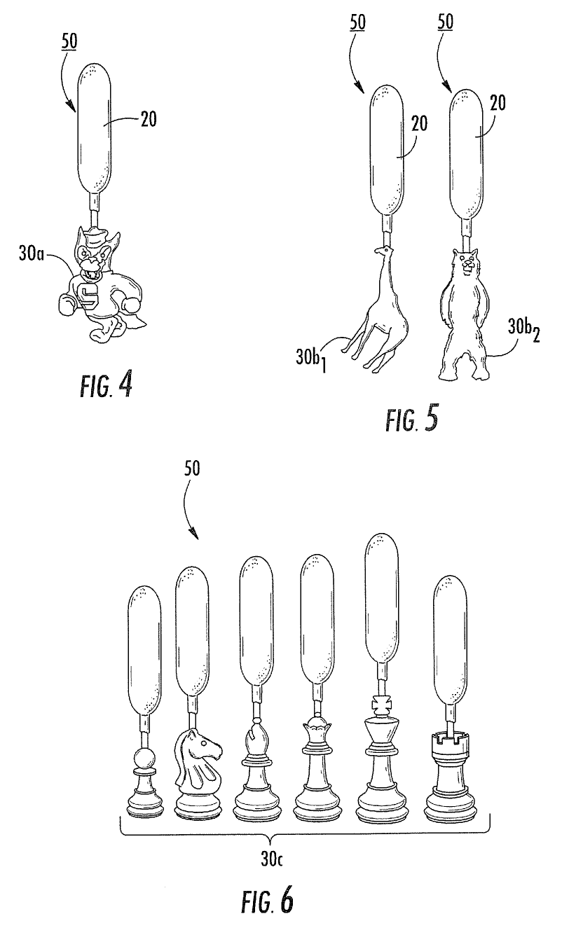

FIG. 4 illustrates that the holder 30 can be configured as a school mascot 30a. FIG. 5 illustrates that the holder 30 can be configured as an animal 30b₁, 30b₂ Similarly, although not shown, the holder 30 can be configured as an insect, bird or reptile and each may be particularly suitable for use with food items at zoos, circuses, nature museums, fraternity houses, and the like. 100591 FIG. 6 illustrates one example of a game-inspired holder. Each holder shown is shaped as a chess piece 30c. FIG. 7 illustrates a number of other exemplary novelty-themed holders 30. The holders can be a single shape or a composite of two or more shapes, e.g., a ball or a ball with a hand. For example, as shown the holder 30 can be shaped and visually configured as a soccer shoe 30d, or soccer shoe and soccer ball 30d₂. Similarly, the holder 30 can be in the shape of a car or other racing themes, such as a “shifter stick” 30e₁, a racing flag with flag pole 30e₂, or a racing car 30e₃. The holder 30 can be in a dance theme, such as ballet slippers and feet 30f, or a ballerina 30f₂. The holder 30 can be in the form of a cowboy boot 30g (for rodeos or country and western events or concerts). Similarly, the holder 30 can be in the shape of a fish 30h or a fish on a fishing pole (not shown) with the pole receiving the stick 10. As also shown, the holder 30 can be in the form of a golf tee 30i₁, a golf ball with tee 30i₂, or a golf club bag 30i₃. For tennis themes, the holder 30 can be in the shape of a tennis ball 30j, and/or racket 30j₂. For boating, the holder 30 can be in the shape of a boat 30k, shown as a sailboat with the stick 20 configured to reside in a pole of the mast. As also shown, the holder 30 can be in the shape of a baseball 301 or a hockey stick 30m. Although not shown, the holder 30 can be in the shape of the STANLEY CUP® trophy with the stick extending through a medial portion thereof. As also shown, the holder 30 can be in the shape of a product for advertising purposes, such as a COCA COLA® bottle 30n or guitar 30p.

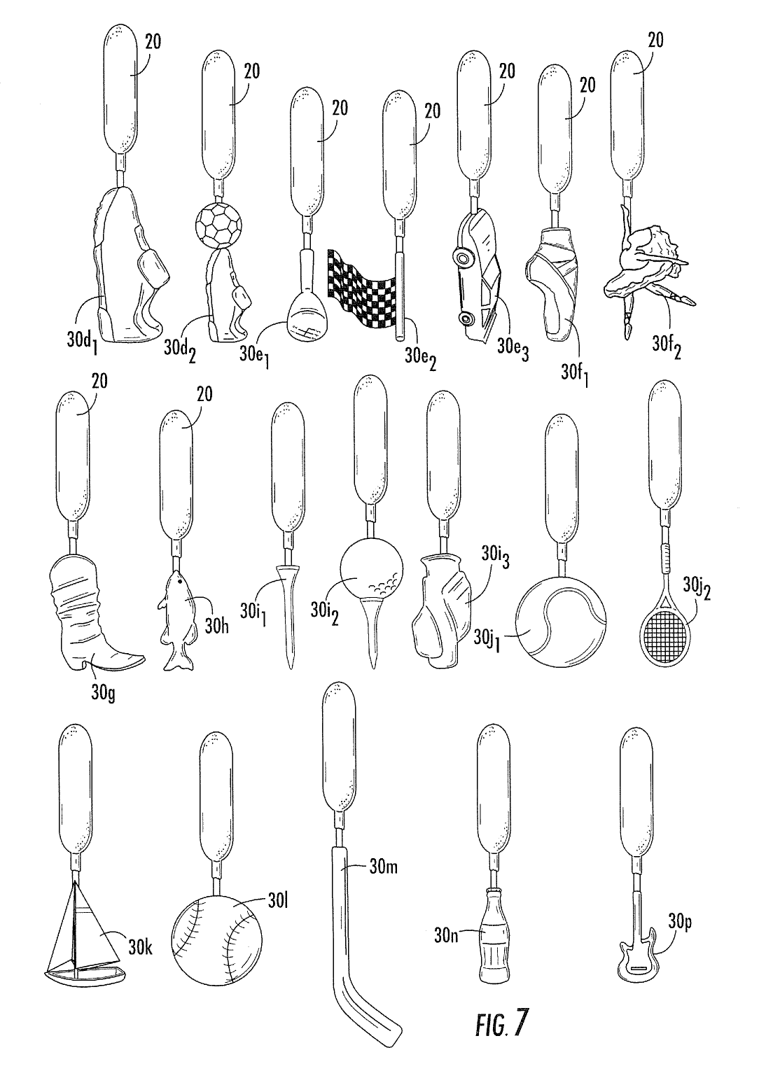

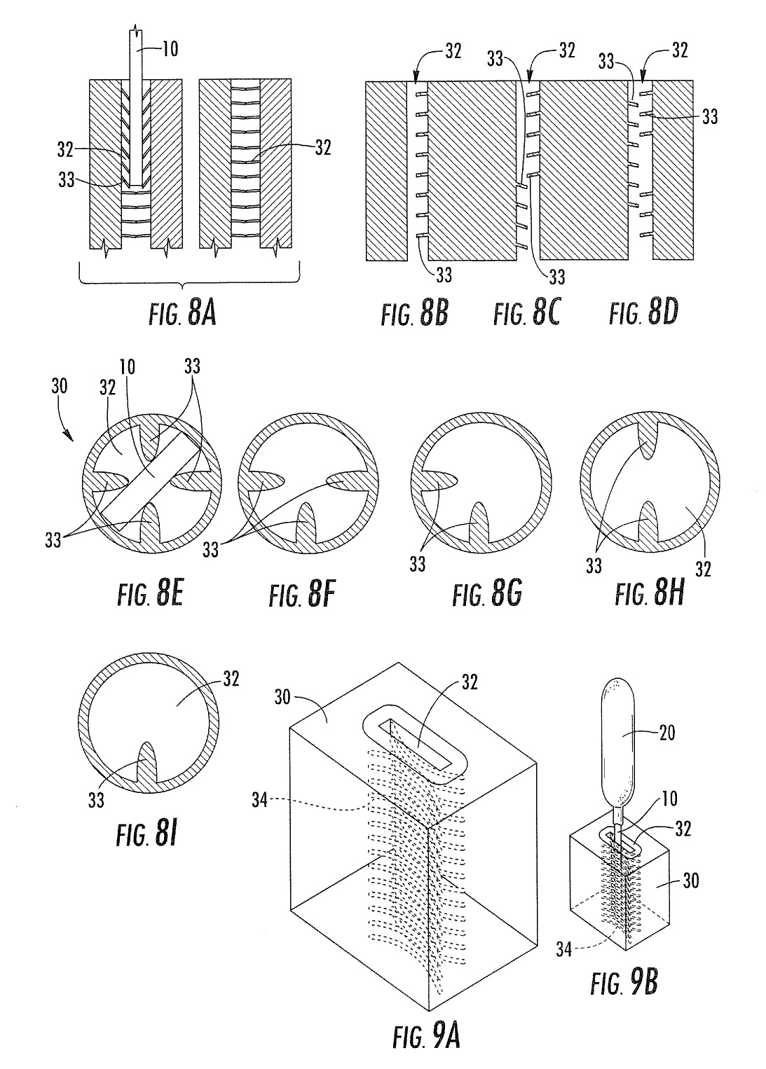

FIGS. 8A-8I illustrate that the cavity 32 of the holder 30 can be include deformable inwardly extending members 33 that partially occlude the cavity 32 and allow passage of the stick 10. The members 33 can be angled downwardly or be configured to bend downwardly upon contact with the stick and configured to allow slidable insertion of the stick into the cavity for releasable retention. The members 33 can be configured to allow bi-directional movement of the stick. The members 33 can be configured to allow easier insertion than removal (increased force/resistance for removal). In some embodiments, the holder 30 has an open lower end with a through cavity 32 and the members can be uni-directional, thereby requiring that the stick 10 be slidably removed from the lower end. The ribs or fins or other inwardly extending members 33 can reside on a single side on opposing sides or at other locations in the cavity 32. The members 33 can extend substantially horizontally or angle downwardly or upwardly, and/or combinations of the above.

FIGS. 9A and 9B illustrate a holder 30 with inwardly extending fins or ribs 34 on opposing sides of the cavity to hold the stick in the cavity 32. The wall with the ribs 34 can spread apart upon contact with the stick 10 without altering the exterior shape of the holder 30.

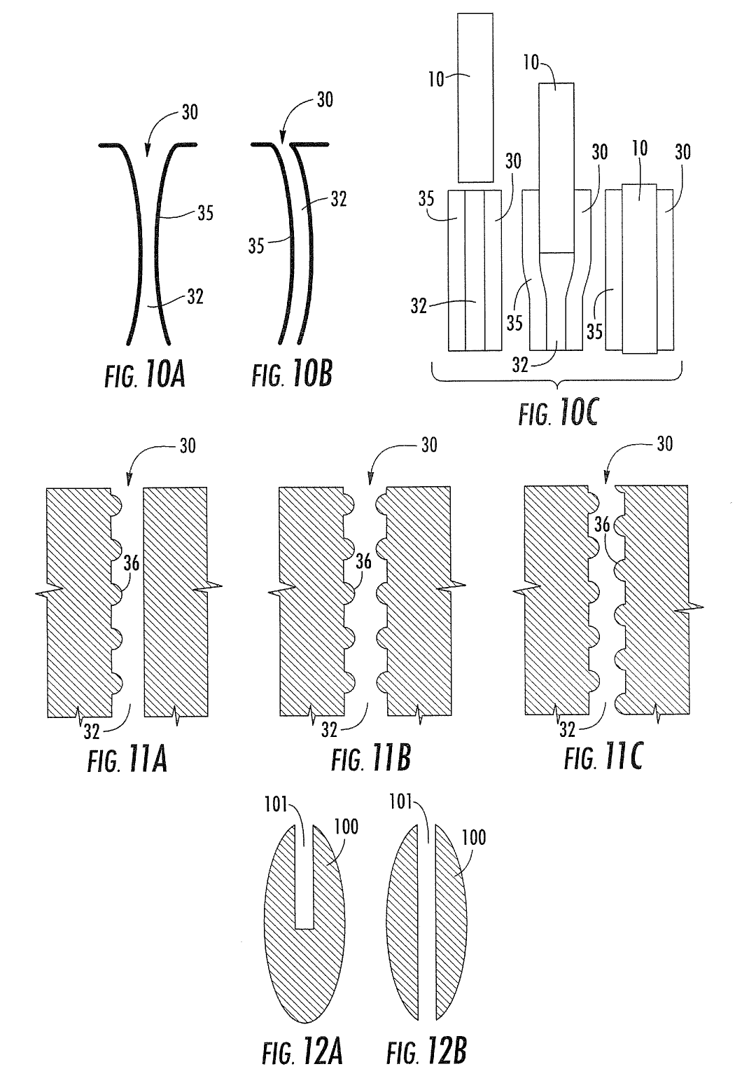

FIGS. 10A and 10B illustrate that the cavity inner wall 33 can be curved. FIG. 10A shows opposing sides of the wall curved toward each other to create a restricted space while FIG. 10B illustrates opposing sides of the wall curving in the same direction with a continuous space that is narrower than the target stick and that can deform to receive the stick 10. In some embodiments, insertion of the stick 10 and/or stick insert 100 (FIG. 12A) into the holder cavity 32 can alter the exterior shape of the holder (FIG. 10C), such as by expanding the cavity and forcing the outer wall 35 outward and/or deforming the outer wall 35 of the holder.

FIGS. 11A-11B shown that the cavity 32 can have a wall 35 with dimples 36 projecting inwardly and the dimples can be sufficiently rigid to retain their shape upon contact with the stick 10. FIG. 11A shows that only a portion of the inner wall can include the dimples 36. FIGS. 11B and 11C show that all or at least opposing surfaces of the wall can include the dimple, with the dimples 36 offset in the embodiment shown in FIG. 11C and transversely aligned as shown in FIG. 11B. In some embodiments, the dimples 36 or other suitable contact engaging configuration can be made of a relatively soft material that can deform in shape when the stick is inserted but create sufficient contact surface area to hold the stick in place during normal usage (e.g., eating).

FIGS. 12A and 12B illustrate that the holder 30 can cooperate with an insert 100 to hold the stick 10. The insert 100 can be snapped, threaded, frictionally engage and/or deform to be slidably received in the holder cavity 32. The insert 100 can have a cavity 101 that extends only a portion of its length as shown in FIG. 12A or that is a through cavity 101 as shown in FIG. 12B.

FIGS. 13A-13D show that the insert 100 and holder 30 can be configured so that (a) the stick 10 is hidden inside the holder 30, (b) the stick 10 extends out under the insert 100 or (c) the stick 10 extends outside the top of the insert 100 and/or holder 30 (FIG. 13D). Although shown in FIGS. 13B-D without the holder for ease of viewing, the insert 100 is typically used with a holder 30. Similar stick and holder configurations can be used without the insert 100.

FIG. 14 illustrates that the holder 30 can include a threaded inner surface 32t forming at least a portion of the cavity 32. The stick 10 and/or insert 100 can include matable threads.

FIGS. 16A-16D illustrate additional novelty themed body part configurations of the holder 30. As shown, the body parts are of humans, but they may also be of humans, animals, fish, birds or reptiles and the like (or combinations of same).

FIG. 17 illustrates that the holder 30 can be configured to allow a user to assemble an assortment of selectable accessory, decorative or other components to the holder body so that a user can “build” a desired look. As shown, the holder 30 includes receiver channels 230ch that matably engage projections 230p on the selectable (and/or interchangeable) components 231, 232, 233. Although shown as an eye 231, nose 232 and mouth 233, the components can be other features, such as body parts, clothing, promotional items, and the like.

FIG. 18 illustrates that the holder 30 can be a multi-component body rather than a unitary body. Although shown as two components, the holder 30 can comprise three or more matable components. The multiple components can be adhesively or mechanically attached to each other and may be permanently or releaseably attached. The attachment can be at the point of sale or prior to the point of sale. As shown in FIGS. 19A-19C, when using a multi-component body, spikes, nails or other attachment members 133 in the cavity 32 can be used to engage and hold the stick 10 and a stick 10 may be inserted before the body is closed together. As shown in FIGS. 20A and 20B, an internal adhesive strip 134 in the cavity 32 may also be used. The internal stick attachment members 133 and/or the adhesive 134 can be positioned in either one or multiple sides/location in the cavity 32 as shown in FIGS. 20A and 20B. The adhesive strip can be provided by one or more pieces of double-sided tape or an adhesive applied directly to the wall of the cavity.

FIG. 18 also illustrates that the stick holder 30 can include an alignment channel or guide 138 that snugly slidably receives the stick 10 or a portion thereof for easy insert of the stick 10. This feature can be used with any holder configuration described herein. As shown, the channel 138 can include at least one substantially planar wall.

FIGS. 21A-21C illustrate that the holder 30 can have a cavity 32 that is undersized (smaller) relative to the target stick 10 (FIG. 21A), about the same in size as shown in FIG. 21B, or larger as shown in FIG. 21C. In some embodiments, such as for the size of the cavity shown in FIGS. 21A and 21B, the wall(s) or one or more sides of the cavity can elastically deform to accept and hold the stick 10. If the cavity 32 is larger, then internal and/or external fixation or engagement features or members can be used to retain the stick in the holder cavity 32.

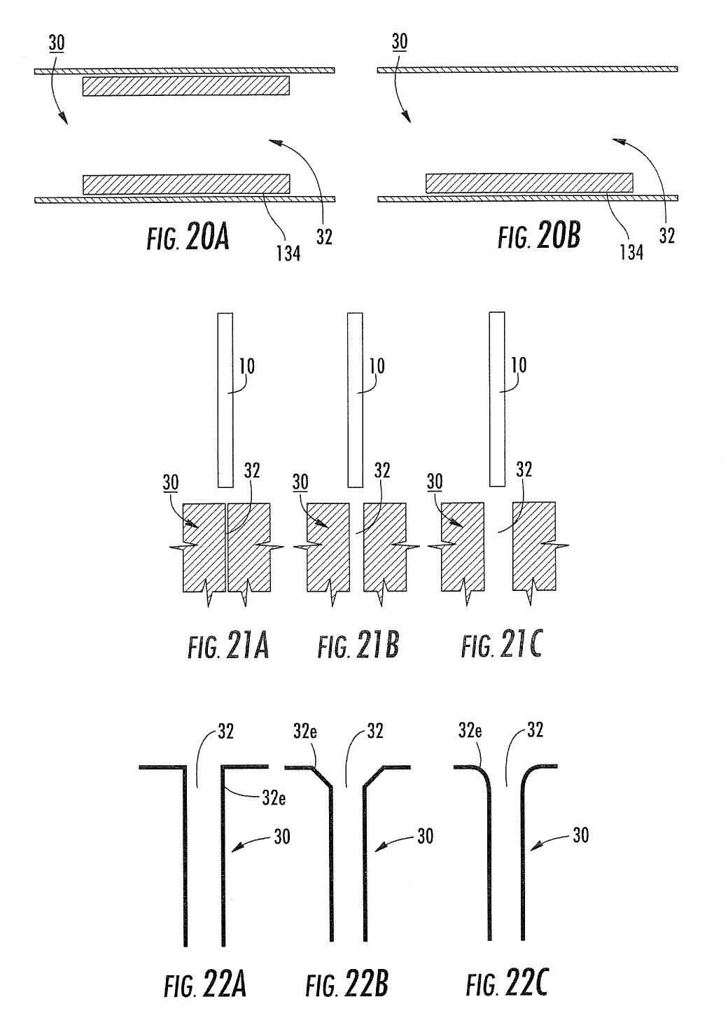

FIGS. 22A-22C illustrate different receiving end portion configurations 32e of the holder cavity 32 according to some embodiments. For example, the end portion 32e can be substantially planar (FIG. 22A), curvilinear (FIG. 22B) and/or formed with rounded entry wall edges (FIG. 22C).

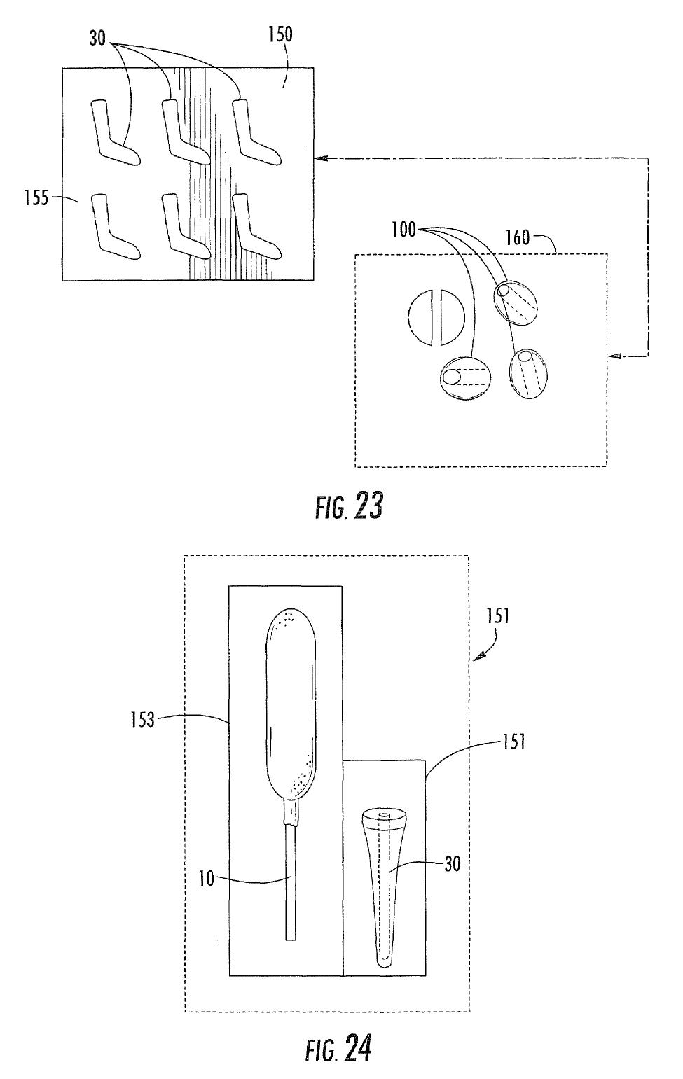

FIG. 23 illustrates a kit 150 of holders 30 in a container 155. The holders 30 and container can be maintained in a clean state to meet regulatory guidelines for food safety as the stick holder will contact food items or be placed next to food. Optionally, the kit 150 can include inserts 100 that can be held in a separate package 160 or in a package or partition within the container 150 of mixed with the holders 30 in the container 150. The holder 30 can be packaged in a wrap that is removable by the end user.

FIG. 24 illustrates a package 151 with a stick holder 30 held inside a package 152 holding the food on the stick 10 in a package 153 and the stick holder packages 152 can be attached or detached from the food package 153.

In some embodiments, the holder 30 can be configured with a locking mechanism that a user can activate or engage to lock and/or release the stick from the cavity 32. The locking mechanism can be a lever arm that extends to positively engage a portion of the stick or other configurations (not shown).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed:

1. A novelty themed stick holder for a food item held on a stick comprising:
an elongate holder having an external surface and opposing top and bottom portions defining an elongate receiving cavity therebetween, the cavity configured and sized to receive a stick therein, wherein an external surface of the holder tapers inwardly from a top portion to a bottom portion and defines a handle portion of a miniature baseball bat.

2. A novelty stick holder according to claim 1, wherein the top portion of the holder is substantially concave with the concavity facing upwardly.

3. A novelty stick holder according to claim 1, in combination with a corn dog or hot dog, wherein the corn dog or hot dog extends above the holder and defines a continuous perimeter line extending from the top portion of the holder to define the medial and top portion of the miniature baseball bat.

4. A novelty stick holder according to claim 1, wherein the holder slidably receives and releasably holds the stick therein.

5. A novelty stick holder according to claim 1, wherein the receiving cavity of the holder is configured to frictionally engage the stick and deform from a pre-insertion shape to an expanded post-insertion shape, without affecting the exterior shape of the holder.

6. A novelty stick holder according to claim 1, wherein the receiving cavity of the holder is configured to frictionally engage the stick and deform from a pre-insertion shape to an expanded post-insertion shape whereby the exterior shape of the holder changes from a pre-insertion shape in response thereto.

7. A novelty stick holder according to claim 1, further comprising an insert with an elongate channel configured to hold the stick in the cavity of the holder.

8. A novelty stick holder according to claim 1, wherein the receiving cavity of the holder comprises a plurality of longitudinally extending inwardly projecting ribs and/or a dense pattern of dimples configured to snugly releasably hold the stick in the holder.

9. A novelty stick holder according to claim 1, wherein the receiving cavity of the holder comprises a plurality of longitudinally extending inwardly projecting resilient fins configured to snugly releasably hold the stick in the holder.

10. A novelty stick holder according to claim 1, wherein when viewed in cross-section, the cavity has a curved inner wall that defines a restricted space downstream of the top of the holder.

11. A novelty stick holder according to claim 2, wherein the food item is a corn dog and the stick is a popsicle-like stick.

12. A novelty stick holder according to claim 2, wherein the food item is a hot dog and the stick is a popsicle-like stick.

13. A novelty stick holder according to claim 1, further comprising a sound generating member.

14. A novelty stick holder according to claim 1, further comprising a battery in communication with a light source, and wherein the stick holder is configured to emit light.

15. A novelty stick holder according to claim 1, further comprising a battery in communication with an LCD held on the holder.

16. A novelty stick holder according to claim 1, further comprising a sound generating member and a light generating member held by the holder.

17. A novelty stick holder according to claim 1, wherein the holder is configured to releasably hold a condiment, wipe or napkin.

18. A novelty stick holder according to claim 1, wherein the holder comprises a clip that holds items on the stick holder.

19. A novelty stick holder according to claim 1, wherein the holder comprises a shallow cavity that holds the condiment, wipe and/or napkin.

20. A novelty stick holder according to claim 1, wherein the cavity is configured to allow only unidirectional movement of a target stick thereinto or therethrough.

21. A novelty stick holder according to claim 1, wherein the cavity is configured to allow bidirectional movement of a target stick.

22. A novelty stick holder for food times held by a stick, comprising:
an elongate themed stick holder body with an external surface and a novelty themed appearance and shape, the holder body having opposing top and bottom portions defining an elongate receiving cavity therebetween, the cavity configured and sized to receive and hold a first end portion of a stick with at least one food item held on an opposing second end portion of the stick.

23. A novelty stick holder according to claim 22, wherein the holder body has a hockey stick shape.

24. A novelty stick holder according to claim 22, wherein the holder body has a school mascot shape and appearance.

25. A novelty stick holder according to claim 22, wherein the holder body has a sports theme shape.

26. A novelty stick holder according to claim 22, wherein the holder body comprises professional or collegiate licensed visual indicia on the external surface.

27. A novelty stick holder according to claim 22, wherein the holder body has a chess piece shape.

28. A novelty stick holder according to claim 22, wherein the holder body has an animal, insect, bird or reptile shape.

29. A novelty stick holder according to claim 22, wherein the holder body comprises a portion with a sports ball shape.

30. A novelty stick holder according to claim 22, wherein the holder body comprises a golf club, golf tee or golf club bag shape.

31. A novelty stick holder according to claim 22, wherein the holder body has a tennis racquet shape.

32. A novelty stick holder according to claim 22, wherein the holder body has a cowboy boot shape.

33. A novelty stick holder according to claim 22, wherein the holder body has a musical instrument shape.

34. A novelty stick holder according to claim 33, wherein the holder body has a guitar shape.

35. A novelty stick holder according to claim 22, wherein the holder body has a flagpole shape with a flag, with the flagpole defining the cavity.

36. A novelty stick holder according to claim 22, wherein the holder body has a racecar shape.

37. A novelty stick holder according to claim 22, wherein the holder comprises an insert configured to releasbly slibably hold the stick in the cavity.

38. A novelty stick holder according to claim 22, in combination with a hot dog or corn dog on a stick.

39. A novelty stick holder according to claim 22, in combination with a frozen food product on a popsicle-like stick.

40. A novelty stick holder according to claim 22, wherein the cavity is configured to allow only unidirectional movement of a target stick.

41. A novelty stick holder according to claim 22, wherein the cavity is configured to allow bidirectional movement of a target stick.

42. A novelty stick holder according to claim 22, wherein the holder comprises edible portions.

43. A novelty stick holder according to claim 22, wherein the holder is edible.

44. A novelty stick holder according to claim 22, wherein the holder is a confectionary food item and wherein the food item comprises a protein food item.

45. A novelty stick holder according to claim 22, wherein the food item is a confectionary food item.

46. A novelty stick holder according to claim 22, wherein a top portion of the holder is substantially concave with the concavity facing upwardly.

47. A novelty stick holder according to claim 22, wherein the holder slidably and snugly receives and releasably holds the stick therein.

48. A novelty stick holder according to claim 22, wherein the cavity of the holder is configured to frictionally engage the stick and deform from a pre-insertion shape to an expanded post-insertion shape, without affecting the exterior shape of the holder.

49. A novelty stick holder according to claim 22, wherein the cavity of the holder is configured to frictionally engage the stick and deform from a pre-insertion shape to an expanded post-insertion shape and also deform the exterior shape of the holder.

50. A novelty stick holder according to claim 22, further comprising an insert with an elongate channel configured to hold the stick in the cavity of the holder.

51. A novelty stick holder according to claim 22, wherein the receiving cavity of the holder comprises a plurality of longitudinally extending inwardly projecting ribs and/or a dense pattern of dimples configured to snugly releasably hold the stick in the holder.

52. A novelty stick holder according to claim 22, wherein the receiving cavity of the holder comprises a plurality of longitudinally extending inwardly projecting resilient fins configured to snugly releasably hold the stick in the holder.

53. A novelty stick holder according to claim 22, wherein when viewed in cross-section, the cavity has a curved inner wall that defines a restricted space downstream of the top of the holder.

54. A novelty stick holder according to claim 22, further comprising a whistle in the holder.

55. A novelty stick holder according to claim 22, further comprising a battery in communication with a light source, and wherein the stick holder is configured to emit light.

56. A novelty stick holder according to claim 22, wherein the holder is configured to releasably hold a condiment, wipe or napkin.

57. A novelty stick holder according to claim 22, wherein the holder comprises a clip that holds the condiment, wipe and/or napkin.

58. A novelty stick holder according to claim 22, wherein the holder comprises a shallow cavity that holds the condiment, wipe and/or napkin.

59. A kit of novelty themed stick holders, comprising:
a container holding a plurality of novelty themed stick holders, each adapted to receive a food item held on a stick, the novelty themed stick holders having an elongate themed stick holder body with an external surface and a novelty themed appearance and shape, the holder body having opposing top and bottom portions defining an elongate receiving cavity therebetween, the cavity configured and sized to receive and hold a stick with a food item thereon in the cavity.

60. A kit according to claim 59, wherein the themed stick holders are individually wrapped for attachment at food dispensing and/or preparation location.

61. A kit according to claim 59, wherein the themed stick holders are held in a bag meeting FDA cleanliness guidelines.

62. A kit according to claim 59, further comprising a plurality of inserts held in the container, wherein a respective insert is adapted to hold a stick holding an edible food item in a cavity of a respective one of the novelty themed stick holders.

63. A novelty stick holder for food times held by a stick, comprising:
an edible elongate themed stick holder body with an external surface and a novelty themed appearance and/or shape, the holder body having opposing top and bottom portions defining an elongate receiving cavity therebetween, the cavity configured and sized to receive and hold a first end portion of a stick with a food item held on an opposing second end portion in the cavity with the food item.

64. A novelty stick holder according to claim 63, wherein the stick holder is a holiday themed stick holder.

65. A novelty stick holder according to claim 63, wherein the stick holder is a confectionary stick holder.

66. A novelty stick holder according to claim 63, wherein the stick holder comprises a protective outer covering material.

67. A novelty stick holder according to claim 63, wherein the food item is a hot dog or a corn dog.
